(19) United States
(12) Patent Application Publication
(10) Pub. No.: US 2026/0058990 A1
(43) Pub. Date: Feb. 26, 2026

(54) SYSTEMS AND TECHNIQUES FOR FAULT INJECTION MITIGATION ON TAMPER RESISTANT ELEMENT

(71) Applicant: QUALCOMM Incorporated, San Diego, CA (US)

(72) Inventors: Or ELNEKAVEH, Hadera (IL); Ofir ALON, Haifa (IL); Kineret BERGER, Kiryat Ata (IL)

(21) Appl. No.: 19/099,012

(22) PCT Filed: Aug. 25, 2023
(86) PCT No.: PCT/US2023/072921

§ 371 Date: Jan. 27, 2025

(30) Foreign Application Priority Data
Sep. 30, 2022 (IL) 296962

(51) Int. Cl. H04L 9/40

(52) U.S. Cl. CPC H04L 63/1466

(57) ABSTRACT

Systems and techniques are provided for a method for fault injection mitigation. For example, a process for fault injection mitigation may include: receiving a sensor event notification: incrementing, based on the sensor event notification, an erasable event counter: making a first determination that an event quantity of the erasable event counter is below an event threshold; and making a second determination, based on the first determination, not to update a permanent event registry.

### CROSS-REFERENCED TO RELATED APPLICATION

This application is a 371 National Stage of PCT Application No. PCT/US2023/072921, filed on Sep. 30, 2022, entitled “SYSTEMS AND TECHNIQUES FOR FAULT INJECTION MITIGATION ON TAMPER RESISTANT ELEMENT”, which claims priority to Isreal Patent Application No. 296962, filed Sep. 30, 2022, and assigned to the assignee hereof. The disclosures of the prior Applications are considered part of and are incorporated by reference into this Patent Application.

### FIELD

The present disclosure generally relates to tamper resistant elements. For example, aspects of the present disclosure relate to performing fault injection mitigation for tamper resistant elements.

### BACKGROUND

Devices often implement various techniques for device security. Device security may relate to securing devices against physical and/or logical attacks seeking to compromise device security. Device security techniques may include configuring a device with a tamper resistant element. A tamper resistant element (TRE) may include any number of sensors for sensing device conditions (e.g., temperature, voltage, signal frequency, etc.). Such sensors may be configured such that, when a sensor value outside a threshold is reached, the sensor provides a sensor event notification. Sensor event notifications are often recorded using memory that may not be erasable. Often, when a number of sensor event notifications exceeds a maximum sensor event quantity a fault mitigation action is performed (e.g., disabling all or any portion of the components of the tamper resistant element, the TRE being reset, etc.). However, such fault mitigation actions may fail to account for the frequency with which sensor events occur, and, thus, may result in disabling all or any portion of a TRE, or resetting a TRE, even when sensor events are not the result of a security attack.

### SUMMARY

Systems and techniques are described for performing fault injection mitigation for tamper resistant elements. For example, the systems and techniques can determine when to register sensor events, which may contribute to determining when to perform fault mitigation actions for devices that include one or more tamper resistant elements.

According to at least one example, a method for fault injection mitigation is provided. The method includes: receiving a sensor event notification; incrementing, based on the sensor event notification, an erasable event counter; making a first determination that an event quantity of the erasable event counter is below an event threshold; and making a second determination, based on the first determination, not to update a permanent event registry.

In another illustrative example, an apparatus for fault injection mitigation is provided. The apparatus may include an erasable event counter; a permanent event registry; at least one memory; and at least one processor coupled to the at least one memory. The apparatus may be configured to: receive, at the erasable event counter, a sensor event notification; increment, based on the sensor event notification, the erasable event counter; make a first determination that an event quantity of the erasable event counter is below an event threshold; and make a second determination, based on the first determination, not to update the permanent event registry.

In another illustrative example, a non-transitory computer readable medium is provided that has stored thereon instructions that, when executed by one or more processors, cause the processors to: receive a sensor event notification; increment, based on the sensor event notification, an erasable event counter; make a first determination that an event quantity of the erasable event counter is below an event threshold; and make a second determination, based on the first determination, not to update a permanent event registry.

In another illustrative example, an apparatus of identity impersonation is provided that includes means for: receiving a sensor event notification; incrementing, based on the sensor event notification, an erasable event counter; making a first determination that an event quantity of the erasable event counter is below an event threshold; and making a second determination, based on the first determination, not to update a permanent event registry.

In some aspects, one or more of the apparatuses described herein is, is part of, and/or includes an extended reality (XR) device or system (e.g., a virtual reality (VR) device, an augmented reality (AR) device, or a mixed reality (MR) device), a mobile device (e.g., a mobile telephone or other mobile device), a wearable device, a wireless communication device, a camera, a personal computer, a laptop computer, a vehicle or a computing device or component of a vehicle, a server computer or server device (e.g., an edge or cloud-based server, a personal computer acting as a server device, a mobile device such as a mobile phone acting as a server device, an XR device acting as a server device, a vehicle acting as a server device, a network router, or other device acting as a server device), another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyrometers, one or more accelerometers, any combination thereof, and/or other sensor.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a block diagram illustrating tamper resistant element, in accordance with some examples.

FIG. 2 is a flow diagram illustrating an example of a process of fault injection mitigation, according to aspects of the disclosure;

FIG. 3 is a diagram illustrating an example of a computing system, according to aspects of the disclosure.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

As used herein, the phrase operatively connected, or operative connection, means that there exists between elements/components/devices, etc. a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices, components, circuitry, etc. connecting the operatively connected devices) connection. Thus, any path through which information of any type may travel may be considered an operative connection. Additionally, operatively connected devices and/or components may exchange things other than information, such as, for example, electrical current, radio frequency signals, etc. Such information may initially be in one form (e.g., an indication of a sensor reading outside of a configured threshold), and, while traversing the operative connection, be transformed into different information (e.g., an operation resulting in an action being taken by and/or to one or more separate components based on one or more sensor readings).

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

Security-hardened hardware, such as a Tamper Resistant Element (TRE), is designed to resist potential attackers. Such attackers are capable of injecting faults, which are designed to disrupt and change expected hardware and software behavior, and modify overall flows of the same. Mitigating fault injection often involves an array of sensors used to monitor the operational conditions (e.g., voltage and frequency) of the security-hardened hardware (e.g., TRE). Once such a sensor or sensors is triggered, the security-hardened hardware (e.g., TRE) would typically protect its data, such as by resetting itself, and preventing an attacker from manipulating hardware/software functionality.

Given that a fault injection attack surface might be significant, and can extend over a long period of time, some sensors may have a terminal limit as to how many times they can trigger. Otherwise, if no limits are placed on certain sensor triggers, an advanced attacker may take advantage of the unlimited amount of sensor events to circumvent fault-injection countermeasures, such as when performed across a long period of time and/or spanning many devices.

Based on such vulnerabilities, it can be desirable to place hardware (e.g., TRE) life-time limits on certain sensors to mitigate such an attack. Once that limit has been reached, the security-hardened hardware (e.g., TRE) will no longer function-all as part of the mitigation.

Given the length of time it takes to write to traditional non-volatile memory (e.g., flash), the record of these sensor events may be stored in one-time programmable memory (OTP), such as an eFuse. However, OTP memory may have a very limited in size, in which case the number of such events is limited. There is no notion of rate, and once written, by definition, OTP memory cannot be erased.

Moreover, despite best design efforts, it can be difficult to prevent certain spurious sensor events, such as in electrically noisy environments, which are beyond the control of security-hardened hardware (e.g., TRE) designers. This can be especially true when considering billions of units and lifetime of TRE that can be measured in years. As such, a percentage of devices may experience spurious events, that while benign, may still accumulate over time, and exceed the life-time limits of the security-hardened hardware (e.g., TRE). This may lead to the security-hardened hardware (e.g., TRE) terminating itself for reasons that are not security-related.

Systems and techniques are described herein for improving the robustness of fault injection mitigation, such as for security-hardened hardware (e.g., TREs) that include one or more of the following features: always-on (AO) register that is persisted across TRE boots; the ability to reliably detect when the AO register was reset (e.g., if power was disconnected); and reliably measure elapsed time from boot. Using the systems and techniques described herein, security-hardened hardware (e.g., TREs) may form an additional layer of fault mitigation, based on AO registers, without relying on finite OTP memory. Such systems and techniques may additionally or alternatively provide the security-hardened hardware (e.g., TREs) with rate-control and re-writability, which is not possible with OTM memory.

The following provides a comparison of a first technique and a second technique provided by the systems and techniques described herein (with a TRE being used as an illustrative example of security-hardened hardware):

| | The first technique | The second technique |
|---|---|---|
| TRE boot | IF OTP memory has registered | IF OTP memory has registered |
| | maximum number of sensor | maximum number of sensor |
| | events, abort TRE boot | events, abort TRE boot |
| | | IF AO register was reset (e.g., if |
| | | power was disconnected from it, |
| | | and it has lost its retained value) |
| | | Reverts to the previous |
| | | mechanism where a sensor |
| | | event is immediately |
| | | recorded in OTP memory |
| TRE Sensor | Register sensor event to OTP | IF AO register value > some |
| event | memory. | maximum value |
| | Reset TRE. | Register event in OTP |
| | | memory |
| | | ELSE |
| | | Increase a counter in AO |
| | | register. |
| | | Reset TRE |
| Some elapsed | No special handling | Decrease/Reset AO register |
| time from boot | (can't undo OTP memory write) | |

The systems and techniques described herein can be used to significantly decrease chances of security-hardened hardware (e.g., TRE) being disabled by spurious sensor events, which is a concern for TRE designers.

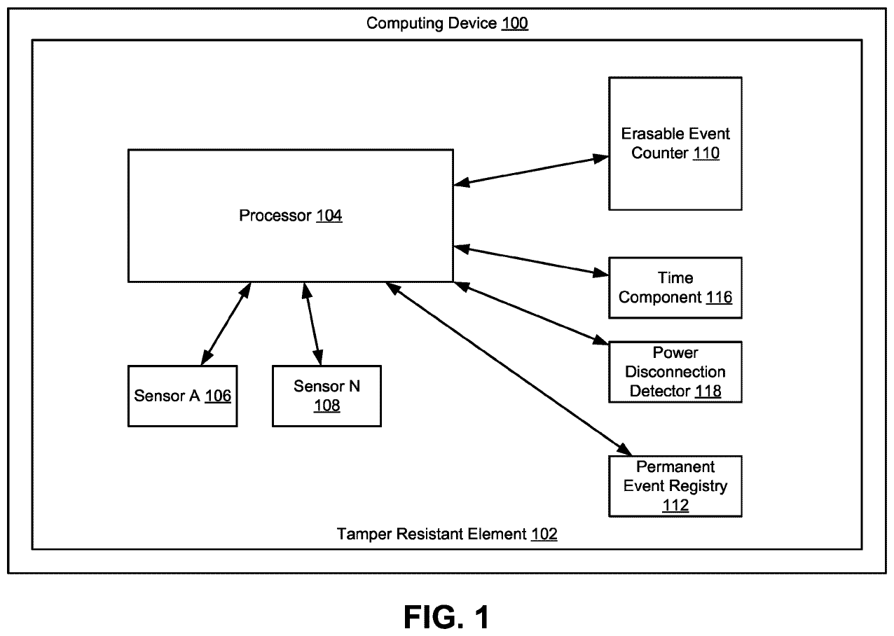

Various aspects of the systems and techniques described herein will be discussed below with respect to the figures. FIG. 1 is a block diagram of a tamper resistant element 102 in accordance with one or more examples described herein. As shown in FIG. 1, the tamper resistant element 102 is included in a computing device 100. The tamper resistant element 102 may include a processor 104, any number of sensors (e.g., the sensor A 106, the sensor N 108, etc.), an erasable event counter 110, a permanent event registry 112, a time component 106, and a power disconnection detector 118. Each of these components is described below.

The computing device 100 is any device, portion of a device, or any set of devices capable of electronically processing instructions and may include, but is not limited to, any of the following: one or more processors (e.g. components that include integrated circuitry, such as the processor 104), memory, input and output device(s) (not shown), non-volatile storage hardware (not shown), one or more physical interfaces (not shown), any number of other hardware components (e.g., the sensors 106 and 108, the erasable event counter 110, the permanent event registry 112, etc.), and/or any combination thereof. Examples of computing devices include, but are not limited to, a mobile device (e.g., laptop computer, smart phone, personal digital assistant, tablet computer, automobile computing system, and/or any other mobile computing device), an Internet of Things (IOT) device, a server (e.g., a blade-server in a blade-server chassis, a rack server in a rack, etc.), a desktop computer, a storage device (e.g., a disk drive array, a fibre channel storage device, an Internet Small Computer Systems Interface (iSCSI) storage device, a tape storage device, a flash storage array, a network attached storage device, etc.), a network device (e.g., switch, router, multi-layer switch, etc.), a wearable device (e.g., a network-connected watch or smartwatch, or other wearable device), a robotic device, a smart television, a smart appliance, an extended reality (XR) device (e.g., augmented reality, virtual reality, etc.), any device that includes one or more SoCs, and/or any other type of computing device with the aforementioned requirements. In one or more examples, any or all of the aforementioned examples may be combined to create a system of such devices, which may collectively be referred to as a computing device. Other types of computing devices may be used without departing from the scope of examples described herein.

In some examples, the computing device 100 includes the tamper resistant element 102. In one or more embodiments, the tamper resistant element 102 is any security element that includes hardware, software, firmware, middleware, and/or any combination thereof that is configured to provide resistance against logical and/or physical attacks attempting to compromise all or any portion of the computing device 100. The tamper resistance element may, for example, be included in and/or operatively connected to one or more subscriber identity modules (SIMs) of any type (e.g., a removable SIM card, eSIM, integrated SIM, payment card chips, etc.) of the computing device 100. In some examples, the tamper resistant element 102 may be subjected to attacks seeking to compromise the tamper resistant element 104 and/or the computing device 100 is some way. As an example, a passive attack may attempt to measure one or more physical aspects of the tamper resistant element (e.g., temperature, electromagnetic emissions, etc.) in order to gain information about the operation of the tamper resistant element 104. As another example, an active attack may attempt to cause all or any portion of the tamper resistant element 104 to alter its operating behavior (e.g., by raising temperature, voltage, current, signal frequency, etc.) in order to generate scenarios that allow for an attack on the security of the tamper resistant element 104. Such attacks may, as an example, allow an attacker to gain insights into the operations of one or more aspects of the computing device 100 (e.g., software program flow) and/or the tamper resistant element 102. Such insights may allow, as an example, for faults to be injected into the operation of the tamper resistant element to allow an attacker an increased likelihood of successfully compromising the security of the tamper resistant element 104 (e.g., by causing an invalid signature to be accepted, etc.).

In one or more embodiments, the tamper resistant element 102 includes and/or is operatively connected to the processor 104. In some examples, the processor 104 is any component that includes circuitry for executing instructions/operations (e.g., of a computer program). As an example, such circuitry may be integrated circuitry implemented, at least in part, using transistors implementing such components as arithmetic logic units, control units, logic gates, registers, etc. In some examples, the processor may include additional components, such as, for example, cache memory. In some examples, to perform operations, a processor retrieves and decodes instructions, which are then executed. Execution of instructions may include operating on data, which may include reading data, writing data, transforming data, etc. In some examples, the instructions and data used by a processor are stored in the memory and/or other components (e.g., registers) of the computing device 100. A processor may perform various operations for executing software, such as operating systems, applications, etc. A processor may cause data to be written from memory to storage of the computing device 100 and/or cause data to be read from storage via the memory. Examples of processors include, but are not limited to, central processing units (CPUs), graphics processing units (GPUs), neural processing units, tensor processing units, data processing units (DPUs), digital signal processors (DSPs), etc.

In some examples, all or any portion of the components of the tamper resistant element 102, such as, for example, those shown in FIG. 1, may be operatively connected to a processor, such as the processor 104 shown in FIG. 1. The processor 104, as described above, may be any circuitry implementing logic of any type and for any purpose. Accordingly, the tamper resistant element 102 may include a processor, as described above, and/or a separate set of processing logic, which may also be referred to as a processor, for implementing all or any portion of the functionality described herein, such as implementing operative connections between all or any portion of the components discussed herein. Said another way, the tamper resistant element 102 may include a set of logic (e.g., fault injection mitigation logic), implemented at least in part in circuitry, that exists alongside any number of other processing elements (e.g., the processor 104). As discussed above, the phrase operative connection, and/or any connecting arrows or lines shown in any Figure, are not intended to exclusively imply a specific, direct coupling between any elements shown in the Figures, but instead are intended to convey that any physical and/or logical operative path through which information, data, etc. may travel, thereby creating a path via which the actions, operations, etc. of one component, element, etc. may influence, affect, etc. the actions, operations, etc. of another component, or any subcomponent therein. As such, although FIG. 1 shows each component being operatively connected via the processor 104, one having ordinary skill in the relevant art will appreciate that other configurations of the tamper resistant element may exist in which different logical groupings may exist, and in which various components, elements, circuitry, etc. exist and may allow for operative connections between any one or more components, elements, etc. As an example, all or any portion of the sensors (e.g., 106, 108), the erasable event counter 110, the time component 116, the power disconnection detector 118, and/or the permanent event registry 112 may be operatively connected by the processor (as shown in FIG. 1), by any other circuitry or components not shown in FIG. 1, or any combination thereof. In some examples, all or any portion of the components shown in FIG. 1 may be logically referred to as fault injection mitigation logic. As an example, the erasable event counter 110, the time component 116, the power disconnection detector, and/or the permanent event registry may be considered as a logical block of elements representing fault injection mitigation logic, and all or any portion of such components may be operatively connected (e.g., logically connected) to each other and/or to the one or more sensors (e.g., 106, 108) such that sensor events, and/or events in any other component, cause changes in the one or more components to which the sensors and/or other components are, logically, connected. Thus, although FIG. 1 shows operative connections between the various other components via the processor 104, in some examples, all or any portion of the various other elements may be additionally or alternatively operatively connected in other ways, using any other direct and/or indirect circuitry, components, etc. in order to perform the various types of functionality described herein. Thus, examples described herein may be performed using the processor 104, other sets of logic included in the tamper resistant element 102, or any combination thereof.

In some examples, the tamper resistant element 102 includes any number of sensors (e.g., sensor A 106, sensor N, 108). Such sensors may be operatively connected to the processor 104, and/or to any other component of the computing device 100. In some examples, a sensor (e.g., 106, 108) may be configured to record, measure, etc. any aspect of the computing device 100 and/or the tamper resistant element 102. Examples of such aspects include temperatures, voltages, currents, signal frequencies, etc. In one or more embodiments, based on the output from a given sensor, a sensor event notification may be generated. In some examples, a sensor event is any aspect or condition of the computing device 100 and/or the tamper resistant element 102 that is outside a configured threshold. As an example, a temperature that may be above or below a temperature range. As another example, a voltage supplied to a given component may be above for below a given voltage range. One of ordinary skill in the art will appreciate that other values may be measured by one or more sensors and compared with various threshold values to discern sensor events without departing from the scope of examples discussed herein.

In some examples, the tamper resistant element 102 includes fault injection mitigation logic (not shown). In some examples, the fault injection mitigation logic is any hardware logic (e.g., circuitry), software, firmware, and/or any combination thereof that is configured to determine when to update a permanent event registry (discussed below) based on sensor event notifications, in some examples by using the erasable event counter 110. As such, the fault injection mitigation logic may include all or any portion of the components shown in FIG. 1, as well as any other circuitry, components, etc. that facilitate communication, resultant actions, etc. between any two or more components of the tamper resistant element 102.

In some examples, the tamper resistant element 102 includes an erasable event counter 110. The erasable event counter 110 may be any hardware (e.g., circuitry), software, firmware, and/or any combination thereof that is configured to record any number of instances of sensor event notifications. As an example, when a sensor (e.g., 106, 108) of the tamper resistant element 102 measures a value that is outside (e.g., above, below, etc.) a configured threshold (e.g., five, ten, one hundred, etc.), the erasable event counter 100 may be updated (e.g., via the processor 104, by separate fault injection mitigation logic). The erasable event counter 110 may be operatively connected to the processor 104 and/or to any other component of the tamper resistant element 102 (e.g., the sensors 106 and 108). In some examples, the erasable event counter 110 may be considered erasable because data, after being written to the erasable event counter, may be erased, altered, etc. (e.g., the counter may be reset, decremented, etc. after a certain amount of time passes)

The erasable event counter 110 may include and/or be operatively connected to an always on register. In some examples, an always on register is a storage element that includes a power source separate from other power provided to various components of the computing device 100 (e.g., via a separate power rail). In some examples, updating the erasable event counter 110 may include incrementing a value stored in the always on register based on a sensor event notification. In some examples, if a value stored by the erasable event counter 110 reaches and/or exceeds a configured value based on a quantity of sensor event notifications, a permanent event registry 112 (discussed below) may be updated. In some examples, an always on register may be updated based on the occurrence of a sensor event, regardless of whether the sensor is directly coupled to the always on register, or if the update is performed via an indirect connection via the processor 104 and/or other fault injection mitigation logic. In some examples, the always on register functions as the erasable event counter 110. In other examples, updates to the always on register may cause an update to a separate, operatively connected erasable event counter.

In some examples, the tamper resistant element 102 includes a time component 116 capable of tracking time (e.g., a counter, timer, etc.). In some examples, the time component 116 is included in and/or operatively connected to the processor 102 and/or to the erasable event counter 110 (e.g., via fault injection mitigation logic). In some examples, the time component 116 may be configured with a time value, which may be referred to as a time threshold (e.g., 10 minutes). As an example, the configured time (e.g., time threshold) may be a time since the computing device 100 and/or the tamper resistant element 102 has booted and/or rebooted. In some examples, if the timer of the time component 116 reaches the configured time limit, an action is performed. As an example, if the timer reaches a configured time limit, the erasable event counter 110 may be reset, thereby restarting the count of sensor event notifications. As another example, if the timer reaches a configured time limit, the erasable event counter 110 may have its count of sensor event notifications decremented by one or more, thereby maintaining a rolling count of sensor event notifications per unit time. In some examples, if the erasable event counter 110 does not reach a configured threshold within a particular amount of time, the permanent event registry 112 is not updated to record the sensor events, which may prevent all or any portion of the tamper resistant element from being unnecessarily disabled or reset (e.g., based on infrequent anomalous sensor events not caused by an attempted attack on the security of the tamper resistant element 102).

In some examples, the erasable event counter 110, as discussed above, is configured to have a consistent supply of power. In some examples, in the event that power is disconnected (e.g., from an always on register), the erasable event counter 110 may lose all or any portion of a quantity of sensor event notifications, which may lead to the sensor event notification quantity being unreliable. In some examples, such a power disconnection may itself be a portion of an attempt to attack (e.g., inject a fault into) the tamper resistant element. Therefore, in some examples, erasable event counter 110 may include and/or be operatively connected (e.g., via the processor 104 and/or via other fault injection mitigation logic) to a power disconnection detector 118 that provides an indication that a power disconnection has occurred for the erasable event counter 110, or any component operatively connected thereto (e.g., an always on register). In some examples, such an indication may cause a change in the configured behavior of the tamper resistant element 102. As an example, the configuration of the tamper resistant element 102 may be updated to cause sensor event notifications to cause (e.g., via the processor 104 and/or via other fault injection mitigation logic) an update of a value stored by a permanent event registry 112 (discussed below) when a sensor event occurs, rather than an update to the erasable event counter 110. In some examples, such a change may be referred to as an update permanent event registry update technique.

In some examples, the tamper resistant element 102 includes a permanent event registry 112. In some examples, the permanent event registry 112 is any hardware, software, firmware, and/or any combination thereof configured to store a quantity of occurrences of sensor event notifications. In some examples, the permanent event registry 112 is referred to a permanent because, as the name implies, information written to the permanent registry 112 may not be erasable or otherwise alterable. As an example, the permanent event registry 112 may be a one time programmable memory device configured to allow information to be written, but not erased. As an example, an occurrence of an event may be written to the permanent event registry 112, but may not be erasable. As such, in some examples, the permanent event registry 112 may record instances of sensor event notifications permanently, that are not erasable. In some examples, the permanent event registry 112 may be configured with a threshold quantity of sensor events that, if reached and/or exceeded, causes the tamper resistant element 110 to disable all or any portion of the components therein (which may be referred to as one example of a fault injection mitigation action). As an example, the tamper resistant element 110 may be included as part of a SIM card. In such a scenario, if the permanent event registry 112 reaches or exceeds a threshold quantity of sensor events, portions of the SIM card that allow network connectivity may be disabled. As another example, a fault injection mitigation action may include a reset of the tamper resistant element 102 and/or all or any portion of the computing device 100. Other actions may be performed as fault injection mitigation actions without departing from the scope of examples described herein.

In some examples, causing portions of a SIM card to be disabled may reduce user satisfaction. Such a decrease in user satisfaction may result even in examples where the sensor events recorded by the permanent event registry 112 are not the result of a security attack. Accordingly, examples described herein employ the above-described erasable event counter 110, and other components of the tamper resistant element 102, to filter instances of sensor event notifications from causing updates to the permanent event registry 112, unless such sensor events occur within certain amounts of time and/or with a certain frequency. As an example, if the erasable event counter has not been updated to reflect the occurrence of more than four sensor events since the last boot of the tamper resistant element 102 within ten minutes of the boot, the erasable event counter may be reset to restart the count for another ten minutes. In such a scenario, the permanent event registry 112 is not updated unless the erasable event counter 110 records a certain number of sensor events over a configured period of time, thereby improving the likelihood that the permanent event registry 112 does not reach a threshold quantity that leads to a fault injection mitigation action unless the sensor events occur at or above a certain frequency level.

Additionally or alternatively, the erasable event counter 110 may be configured to be decremented after a configured amount of time, which may allow the erasable event counter to have a rolling count of sensor events per a certain period of time. In such a scenario, the permanent event registry 112 may only be updated when the erasable event counter exceeds a configured threshold for a given period of time, thereby improving the likelihood that the permanent event registry 112 does not reach a threshold quantity that leads to a fault injection mitigation action unless the sensor events occur at or above a certain frequency level.

As an example, consider a scenario in which a mobile device that includes a SIM card is sometimes placed on the dashboard of a vehicle in a hot environment (increasing device temperature from time to time), and is also sometimes charged with a charger that provides inconsistent voltage inputs to the device. The SIM card includes a tamper resistant element that includes at least a temperature sensor and a voltage sensor, as well as a one time programmable memory device as a permanent event registry. Without the use of examples described herein that include an erasable event counter, the temperature increases, and inconsistent voltage inputs cause sensor events that lead to updates to the permanent event registry. Over time, the repeated temperature increases, and inconsistent voltage inputs, may cause the quantity of sensor events recorded by the permanent event registry to reach and/or exceed a configured threshold of such events. Once such a threshold is reached, the tamper resistant element may disable all or any portion of the SIM card in the interest of preventing possible fault injection. Such a fault injection mitigation action may render all or any portion of the mobile device inoperable, which may cause a decrease in user satisfaction for the device, as the sensor events were not the result of an actual security attack.

Examples discussed herein can improve the operation of such a mobile device by including an erasable event counter configured to track sensor events per a configured amount of time. Such examples may only update the permanent event registry when a frequency of sensor events reaches or exceeds a configured value. Thus, rather than performing a fault injection mitigation action based on an aggregate quantity of sensor events irrespective of the frequency of such events, a fault injection mitigation action may be performed only when detected sensor events are occurring frequently enough to reach and/or exceed a threshold value for such events.

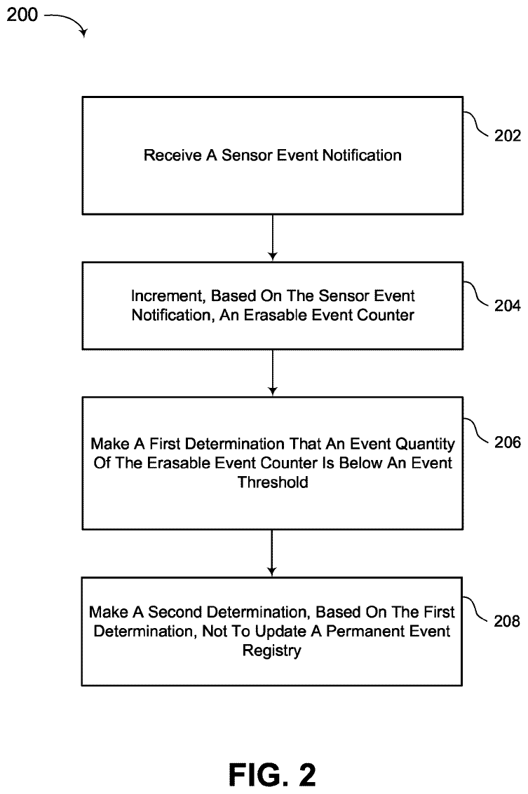

FIG. 2 illustrates an example of a process 200 for performing fault injection mitigation, according to techniques described herein. The process 200 may be performed by a device, such as the computing device 100 of FIG. 1, or a component (e.g., a chipset, processor, memory, any combination thereof, and/or other component) of the device.

At block 202, the first device (or component thereof) may receive a sensor event notification. As an example, a sensor event (e.g., based on a reading from a temperature sensor, a voltage sensor, etc.) may indicate a value outside a configured threshold, which may trigger a sensor event notification being provided to the erasable event counter. Such a notification may be provided directly from the sensors, or via any other operative (e.g., logical) connection between a sensor and the erasable event counter (e.g., via a processor, via any other fault injection mitigation logic, any combination thereof, etc.)

At block 204, the first device (or component thereof) may increment, based on the sensor event notification, an erasable event counter.

At block 206, the first device (or component thereof) may make a first determination that an event quantity of the erasable event counter is below an event threshold. In some examples, an event threshold refers to a threshold quantity of sensor event notifications that may, for example, be recorded via the erasable event counter.

At block 208, the first device (or component thereof) may make a second determination, based on the first determination, not to update a permanent event registry. In some examples, although not shown in FIG. 2, sometime later, an additional sensor event notification may be received, which may cause the erasable event counter to again be incremented. Such an incrementing may cause the erasable event counter to be above the event threshold, which may cause an update of the permanent event registry. In some examples, the update of the permanent event registry may cause a value stored in the permanent event registry to exceed a maximum sensor event threshold. In some examples, the maximum sensor event threshold is a configurable value that, if reached and/or exceeded, causes the performance of a fault injection mitigation action (e.g., a disabling of all or any portion of a tamper resistant element and/or computing device).

In some cases, the devices or apparatuses configured to perform the operations of the process 200 and/or other processes described herein may include a processor, microprocessor, microcomputer, or other component of a device that is configured to carry out the steps of the process 200 and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the process 200 and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 200 is illustrated as a logical flow diagram, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the process 200 and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

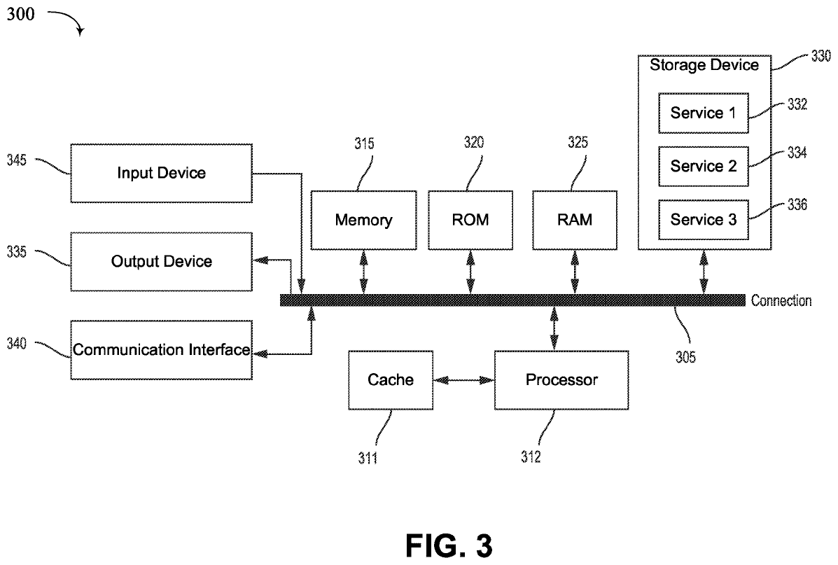

FIG. 3 is a diagram illustrating an example of a system for implementing certain aspects of the present technology. In particular, FIG. 3 illustrates an example of computing system 300, which can be for example any computing device making up internal computing system, a remote computing system, a camera, or any component thereof in which the components of the system are in communication with each other using connection 305. Connection 305 can be a physical connection using a bus, or a direct connection into processor 310, such as in a chipset architecture. Connection 305 can also be a virtual connection, networked connection, or logical connection.

In some aspects, computing system 300 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 300 includes at least one processing unit (CPU or processor) 310 and connection 305 that couples various system components including system memory 315, such as read-only memory (ROM) 320 and random-access memory (RAM) 325 to processor 310.

Computing system 300 can include a cache 311 of high-speed memory connected directly with, in close proximity to, or integrated as part of processor 310.

Processor 310 can include any general-purpose processor and a hardware service or software service, such as services 332, 334, and 336 stored in storage device 330, configured to control processor 310 as well as a special-purpose processor where software instructions are incorporated into the actual processor design. Processor 310 may essentially be a completely self-contained computing system, containing multiple cores or processors, a bus, memory controller, cache, etc. A multi-core processor may be symmetric or asymmetric.

To enable user interaction, computing system 300 includes an input device 345, which can represent any number of input mechanisms, such as a microphone for speech, a touch-sensitive screen for gesture or graphical input, keyboard, mouse, motion input, speech, etc. Computing system 300 can also include output device 335, which can be one or more of a number of output mechanisms. In some instances, multimodal systems can enable a user to provide multiple types of input/output to communicate with computing system 300. Computing system 300 can include communications interface 340, which can generally govern and manage the user input and system output.

The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, WLAN signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/long term evolution (LTE) cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 340 may also include one or more GNSS receivers or transceivers that are used to determine a location of the computing system 300 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 330 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a Europay, Mastercard and Visa (EMV) chip, a subscriber identity module (SIM) card, a mini/micro/nano/pico SIM card, another integrated circuit (IC) chip/card, RAM, static RAM (SRAM), dynamic RAM (DRAM), ROM, programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 330 can include software services, servers, services, etc., that when the code that defines such software is executed by the processor 310, it causes the system to perform a function. In some aspects, a hardware service that performs a particular function can include the software component stored in a computer-readable medium in connection with the necessary hardware components, such as processor 310, connection 305, output device 335, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“>”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

### Illustrative Aspects of the Disclosure Include:

Aspect 1: A method for fault injection mitigation, the method comprising: receiving a sensor event notification; incrementing, based on the sensor event notification, an erasable event counter; making a first determination that an event quantity of the erasable event counter is below an event threshold; and making a second determination, based on the first determination, not to update a permanent event registry.
Aspect 2: The method of aspect 1, further comprising: receiving an additional sensor event notification; incrementing, based on the additional sensor event notification, the erasable event counter; making a third determination that the event quantity of the erasable event counter is above the event threshold; and updating the permanent event registry based on the third determination.
Aspect 3: The method of cany of aspects 1 or 2, further comprising: making a fourth determination, after updating the permanent event registry, that a maximum sensor event threshold is reached; and performing a fault injection mitigation action based on the fourth determination.
Aspect 4: The method of any of aspects 1-3, wherein the fault injection mitigation action comprises disabling at least a portion of a tamper resistant element.
Aspect 5: The method of any of aspects 1-4, further comprising: detecting a power disconnection event for an always on register operatively connected to the erasable event counter; and updating, based on the power disconnection event, a permanent event registry update technique to register all sensor events in the permanent event registry.
Aspect 6: The method of any of aspects 1-5, further comprising: making a third determination that a time threshold for the erasable event counter is reached; and resetting the erasable event counter based on the third determination.
Aspect 7: The method of any of aspects 1-6, further comprising: making a third determination that a time threshold for the erasable event counter is reached; and decrementing the erasable event counter based on the third determination.
Aspect 8: The method of any of aspects 1-7, wherein the sensor event notification is received based on a temperature sensor reading.
Aspect 9: The method of any of aspects 1-8, wherein the sensor event notification is received based on a voltage sensor reading.
Aspect 10: The method of any of aspects 1-9, wherein the sensor event notification is received based on a signal frequency sensor reading.
Aspect 11: An apparatus for fault injection mitigation, including: an erasable event counter; a permanent event registry; at least one memory; and at least one processor coupled to the at least one memory, wherein the apparatus is configured to: receive, at the erasable event counter, a sensor event notification; increment, based on the sensor event notification, the erasable event counter; make a first determination that an event quantity of the erasable event counter is below an event threshold; and make a second determination, based on the first determination, not to update the permanent event registry.
Aspect 12: The apparatus of aspect 11, wherein the apparatus is further configured to: receive an additional sensor event notification; increment, based on the additional sensor event notification, the erasable event counter; make a third determination that the event quantity of the erasable event counter is above the event threshold; and update the permanent event registry based on the third determination.
Aspect 13: The apparatus of aspects 11 or 12, wherein the apparatus is further configured to: make a fourth determination, after updating the permanent event registry, that a maximum sensor event threshold is reached; and perform a fault injection mitigation action based on the fourth determination.
Aspect 14: The apparatus of any of aspects 11-13, wherein the fault injection mitigation action comprises disabling at least a portion of a tamper resistant element.
Aspect 15: The apparatus of any of aspects 11-14, wherein the apparatus is further configured to: detect a power disconnection event for an always on register operatively connected to the erasable event counter; and update, based on the power disconnection event, a permanent event registry update technique to register all sensor events in the permanent event registry.
Aspect 16: The apparatus of any of aspects 11-15, wherein the apparatus is further configured to: make a third determination that a time threshold for the erasable event counter is reached; and reset the erasable event counter based on the third determination.
Aspect 17: The apparatus of any of aspects 11-16, wherein the apparatus is further configured to: make a third determination that a time threshold for the erasable event counter is reached; and decrement the erasable event counter based on the third determination.
Aspect 18: The apparatus of any of aspects 11-17, wherein the sensor event notification is received based on a temperature sensor reading.
Aspect 19: The apparatus of any of aspects 11-18, wherein the sensor event notification is received based on a voltage sensor reading.
Aspect 20: The apparatus of any of aspects 11-19, wherein the sensor event notification is received based on a signal frequency sensor reading.
Aspect 21: A non-transitory computer-readable medium having stored thereon instructions that, when executed by one or more processors, cause the one or more processors to: receive a sensor event notification; increment, based on the sensor event notification, an erasable event counter; make a first determination that an event quantity of the erasable event counter is below an event threshold; and make a second determination, based on the first determination, not to update a permanent event registry.
Aspect 21: The non-transitory computer readable medium of aspect 21, having stored thereon further instructions that, when executed by the one or more processors, cause the one or more processors to: receive an additional sensor event notification; increment, based on the additional sensor event notification, the erasable event counter; make a third determination that the event quantity of the erasable event counter is above the event threshold; and update the permanent event registry based on the third determination.
Aspect 23: The non-transitory computer readable medium of aspects 21 or 22, having stored thereon further instructions that, when executed by the one or more processors, cause the one or more processors to: make a fourth determination, after updating the permanent event registry, that a maximum sensor event threshold is reached; and perform a fault injection mitigation action based on the fourth determination.
Aspect 24: The non-transitory computer readable medium of any of aspects 21-23, wherein the fault injection mitigation action comprises disabling at least a portion of a tamper resistant element.
Aspect 25: The non-transitory computer readable medium of any of aspects 21-24, having stored thereon further instructions that, when executed by the one or more processors, cause the one or more processors to: detect a power disconnection event for an always on register operatively connected to the erasable event counter; and update, based on the power disconnection event, a permanent event registry update technique to register all sensor events in the permanent event registry.
Aspect 26: The non-transitory computer readable medium of any of aspects 21-25, having stored thereon further instructions that, when executed by the one or more processors, cause the one or more processors to: make a third determination that a time threshold for the erasable event counter is reached; and reset the erasable event counter based on the third determination.
Aspect 27: The non-transitory computer readable medium of any of aspects 21-26, having stored thereon further instructions that, when executed by the one or more processors, cause the one or more processors to: make a third determination that a time threshold for the erasable event counter is reached; and decrement the erasable event counter based on the third determination.
Aspect 28: The non-transitory computer readable medium of any of aspects 21-27, wherein the sensor event notification is received based on a temperature sensor reading.
Aspect 29: The non-transitory computer readable medium of any of aspects 21-28, wherein the sensor event notification is received based on a voltage sensor reading.
Aspect 30: The non-transitory computer readable medium of any of aspects 21-29, wherein the sensor event notification is received based on a signal frequency sensor reading.
Aspect 30: An apparatus for fault injection mitigation, including one or more means for perform operations according to any of aspects 1-10.

1. A method for fault injection mitigation, the method comprising:
receiving a sensor event notification;
incrementing, based on the sensor event notification, an erasable event counter;
making a first determination that an event quantity of the erasable event counter is below an event threshold; and
making a second determination, based on the first determination, not to update a permanent event registry.

2. The method of claim 1, further comprising:
receiving an additional sensor event notification;
incrementing, based on the additional sensor event notification, the erasable event counter;
making a third determination that the event quantity of the erasable event counter is above the event threshold; and
updating the permanent event registry based on the third determination.

3. The method of claim 2, further comprising:
making a fourth determination, after updating the permanent event registry, that a maximum sensor event threshold is reached; and
performing a fault injection mitigation action based on the fourth determination.

4. The method of claim 3, wherein the fault injection mitigation action comprises disabling at least a portion of a tamper resistant element.

5. The method of claim 1, further comprising:
detecting a power disconnection event for an always on register operatively connected to the erasable event counter; and
updating, based on the power disconnection event, a permanent event registry update technique to register all sensor events in the permanent event registry.

6. The method of claim 1, further comprising:
making a third determination that a time threshold for the erasable event counter is reached; and
resetting the erasable event counter based on the third determination.

7. The method of claim 1, further comprising:
making a third determination that a time threshold for the erasable event counter is reached; and
decrementing the erasable event counter based on the third determination.

8. The method of claim 1, wherein the sensor event notification is received based on a temperature sensor reading.

9. The method of claim 1, wherein the sensor event notification is received based on a voltage sensor reading.

10. The method of claim 1, wherein the sensor event notification is received based on a signal frequency sensor reading.

11. An apparatus for fault injection mitigation, the apparatus comprising:
an erasable event counter;
a permanent event registry;
at least one memory; and
at least one processor coupled to the at least one memory, wherein the apparatus is configured to:
receive, at the erasable event counter, a sensor event notification;
increment, based on the sensor event notification, the erasable event counter;
make a first determination that an event quantity of the erasable event counter is below an event threshold; and
make a second determination, based on the first determination, not to update the permanent event registry.

12. The apparatus of claim 11, wherein the apparatus is further configured to:
receive an additional sensor event notification;
increment, based on the additional sensor event notification, the erasable event counter;
make a third determination that the event quantity of the erasable event counter is above the event threshold; and
update the permanent event registry based on the third determination.

13. The apparatus of claim 12, wherein the apparatus is further configured to:
make a fourth determination, after updating the permanent event registry, that a maximum sensor event threshold is reached; and
perform a fault injection mitigation action based on the fourth determination.

14. The apparatus of claim 13, wherein the fault injection mitigation action comprises disabling at least a portion of a tamper resistant element.

15. The apparatus of claim 11, wherein the apparatus is further configured to:
detect a power disconnection event for an always on register operatively connected to the erasable event counter; and
update, based on the power disconnection event, a permanent event registry update technique to register all sensor events in the permanent event registry.

16. The apparatus of claim 11, wherein the apparatus is further configured to:
make a third determination that a time threshold for the erasable event counter is reached; and
reset the erasable event counter based on the third determination.

17. The apparatus of claim 11, wherein the apparatus is further configured to:
make a third determination that a time threshold for the erasable event counter is reached; and
decrement the erasable event counter based on the third determination.

18. The apparatus of claim 11, wherein the sensor event notification is received based on a temperature sensor reading.

19. The apparatus of claim 11, wherein the sensor event notification is received based on a voltage sensor reading.

20. The apparatus of claim 11, wherein the sensor event notification is received based on a signal frequency sensor reading.

21-30. (canceled)
